(19) United States
(12) Patent Application Publication
(10) Pub. No.: US 2024/0289560 A1
(43) Pub. Date: Aug. 29, 2024

(54) PROMPT ENGINEERING AND AUTOMATED QUALITY ASSESSMENT FOR LARGE LANGUAGE MODELS

(71) Applicant: UnitedHealth Group Incorporated, Minnetonka, MN (US)

(72) Inventors: Damian KELLY, Kildare (IE); Vivek BHADAURIA, Bothell, WA (US); Andrey VOLOZIN, Redmond, WA (US); Sanjeeva L. FERNANDO, Cohasset, MA (US)

(21) Appl. No.: 18/589,179

(22) Filed: Feb. 27, 2024

Related U.S. Application Data
(60) Provisional application No. 63/487,037, filed on Feb. 27, 2023.

(51) Int. Cl. G06F 40/40; G06F 16/35

(52) U.S. Cl. CPC G06F 40/40; G06F 16/35

(57) ABSTRACT

Various embodiments of the present disclosure provide prompt engineering and text quality assessment techniques for improving generative text outputs. The techniques may include identifying an initial document subset for a generative text request that includes a request to generate a generative text document based on one or more request text fields. The techniques may include generating a contextual classification for the one or more request text fields and identifying a refined document subset based on the contextual classification. The techniques may include generating one or more request field embeddings respectively corresponding to the one or more request text fields and identifying a prompt document subset based on the one or more request field embeddings. The techniques may include generating, using a large language model, one or more generative text fields using a generative model prompt based on the prompt document subset and the one or more request text fields.

### CROSS-REFERENCE TO RELATED APPLICATIONS

This application claims the benefit of U.S. Provisional Application No. 63/487,037, entitled “Adaptations Of GPT3 Architecture To Assist With Writing Of Appeal Decision Letters,” and filed Feb. 27, 2023, the entire contents of which are herein incorporated by reference.

### BACKGROUND

Various embodiments of the present disclosure address technical challenges related to natural language processing and large language modeling techniques. Traditional large language models (LLMs) are subject to a number of technical challenges including inaccurate hallucinations of text, among others, which limit the reliability of generative text output by such models. In some cases, prompting techniques may be leveraged to guide the generation of text using examples of acceptable outputs. The reliability of such techniques depends on the quality of the prompt provided to a model. The creation of quality prompts is time consuming and expensive. Moreover, a quality prompt is often case specific making traditional prompting techniques impractical for diverse use cases. Even if done properly, there is a lack of reliable quality assessment techniques for generative text to verify the quality of LLM outputs.

Various embodiments of the present disclosure make important contributions to traditional natural language processing and large language modeling techniques by addressing these technical challenges, among others.

### BRIEF SUMMARY

Various embodiments of the present disclosure provide prompt engineering and quality assessment techniques that improve traditional generative text techniques, such as those that leverage LLMs. To do so, some embodiments of the present disclosure provide a multi-stage prompt engineering process to automatically generate a generative model prompt from a comprehensive data store. By doing so, generative model prompts may be automatically generated for a particular text generation task to alleviate technical challenges that traditionally hinder the performance of generative models. To ensure quality performance of the prompt engineering techniques, some embodiments of the present disclosure provide a quality assessment process that leverages a new machine learning model and feature engineering techniques directly tailored for the machine learning model to generate a simulated ranking of generative text output by a generative model. This, in turn, enables an improved generative text pipeline that directly addresses technical challenges within the realm of generative text techniques, such as inaccurate hallucinations, and readability, among others.

In some embodiments, a computer-implemented method comprises identifying, by one or more processors and from a document data store, an initial document subset for a generative text request that comprises a request to generate a generative text document based on one or more request text fields; generating, by the one or more processors and using a machine learning classifier model, a contextual classification for the one or more request text fields; identifying, by the one or more processors and from the initial document subset, a refined document subset based on the contextual classification; generating, by one or more processors and using a machine learning embedding model, one or more request field embeddings respectively corresponding to the one or more request text fields; identifying, by the one or more processors and from the refined document subset, a prompt document subset based on the one or more request field embeddings; generating, by the one or more processors and using a large language model (LLM), one or more generative text fields using a generative model prompt based on the prompt document subset and the one or more request text fields; and providing, by the one or more processors, a request response comprising the generative text document based on the one or more generative text fields.

In some embodiments, a computing system comprises memory and one or more processors that are communicatively coupled to the memory, the one or more processors are configured to identify, from a document data store, an initial document subset for a generative text request that comprises a request to generate a generative text document based on one or more request text fields; generate, using a machine learning classifier model, a contextual classification for the one or more request text fields; identify, from the initial document subset, a refined document subset based on the contextual classification; generate, using a machine learning embedding model, one or more request field embeddings respectively corresponding to the one or more request text fields; identify, from the refined document subset, a prompt document subset based on the one or more request field embeddings; generate, using a large language model (LLM), one or more generative text fields using a generative model prompt based on the prompt document subset and the one or more request text fields; and provide a request response comprising the generative text document based on the one or more generative text fields.

In some embodiments, one or more non-transitory computer-readable storage media includes instructions that, when executed by one or more processors, cause the one or more processors to identify, from a document data store, an initial document subset for a generative text request that comprises a request to generate a generative text document based on one or more request text fields; generate, using a machine learning classifier model, a contextual classification for the one or more request text fields; identify, from the initial document subset, a refined document subset based on the contextual classification; generate, using a machine learning embedding model, one or more request field embeddings respectively corresponding to the one or more request text fields; identify, from the refined document subset, a prompt document subset based on the one or more request field embeddings; generate, using a large language model (LLM), one or more generative text fields using a generative model prompt based on the prompt document subset and the one or more request text fields; and provide a request response comprising the generative text document based on the one or more generative text fields.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a dataflow diagram showing example data structures and modules for generating a generative text document in accordance with some embodiments discussed herein.

FIG. 5 is an operational example of a rating simulation model in accordance with some embodiments discussed herein.

FIG. 6 is an activity diagram showing example entity to entity interactions in accordance with some embodiments discussed herein.

FIG. 7 is an operational example of a branched processing architecture in accordance with some embodiments discussed herein.

FIG. 8 is a flowchart diagram of an example process for generating a generative text document in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

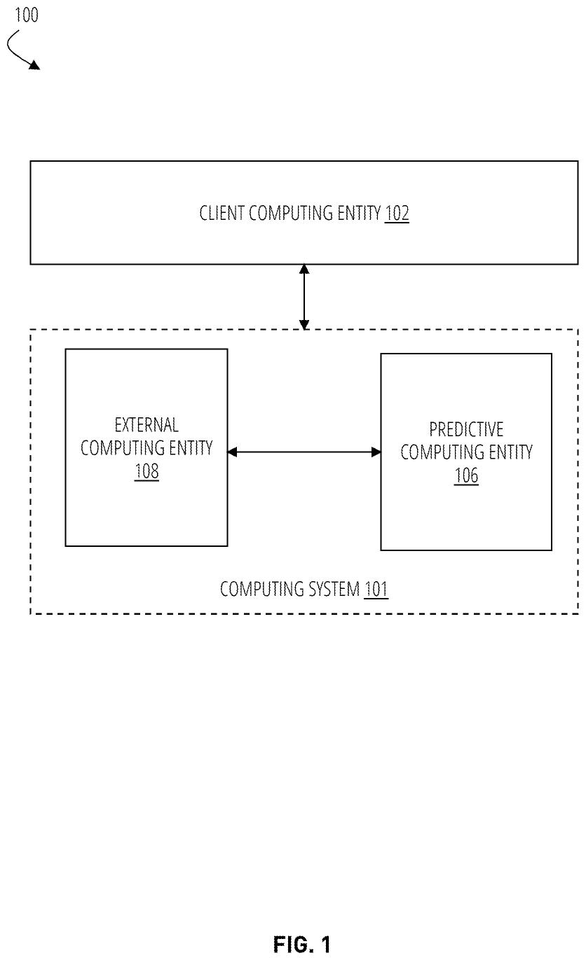

FIG. 1 provides an example overview of an architecture 100 in accordance with some embodiments of the present disclosure. The architecture 100 includes a computing system 101 configured to receive request, such as generative text requests, from client computing entities 102, process the requests to generate generative text outputs, and provide the generated text outputs to the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, one or more machine learning models may be trained to generate one or more classifications, generative text, and/or simulated rating. The models may form a machine learning pipeline that may be configured to automatically generate a generative model prompt, leverage the generative model prompt to generate generative text, and then evaluate the quality of the generative text. This technique will lead to more accurate and reliable generative text modelling techniques that may be efficiently used for a diverse set of different cases.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive requests from client computing entities 102, process the requests to generate outputs, such as generative model prompts, generative text, rating score, and/or the like, and provide the generated outputs to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., generative text techniques, classification techniques, simulation techniques, and/or the like) described herein. The external computing entities 108, for example, may include and/or be associated with one or more entities that may be configured to receive, transmit, store, manage, and/or facilitate datasets, such as the document data store, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

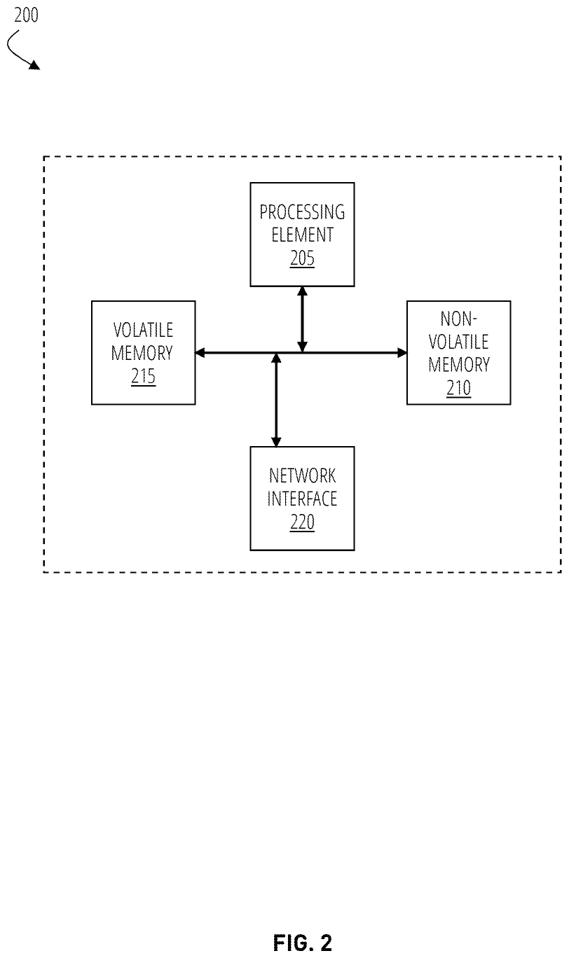

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

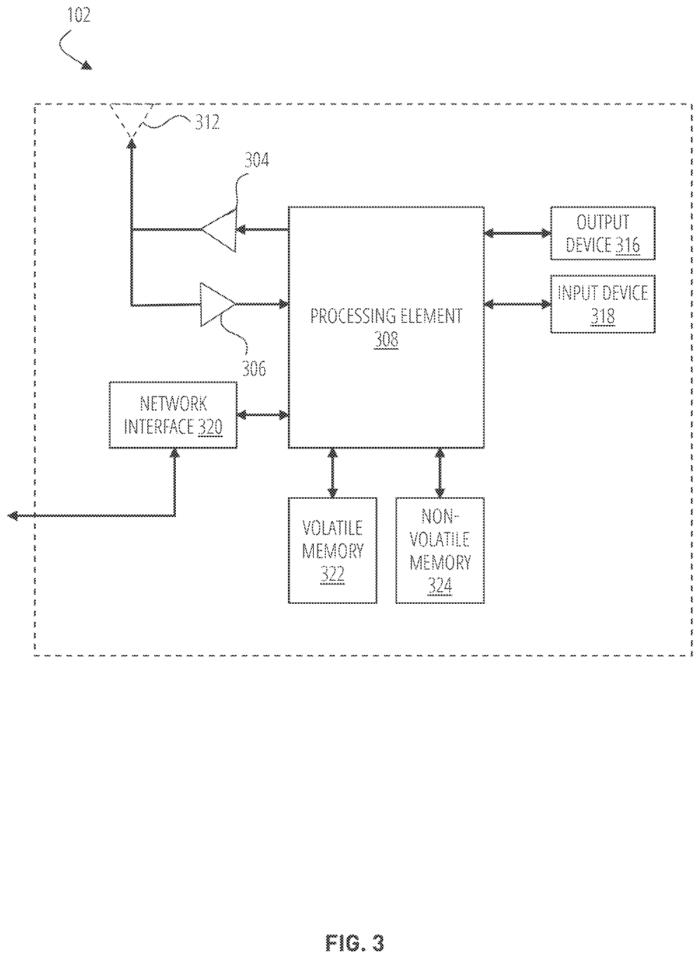

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. Examples of Certain Terms

In some embodiments, the term “controlled text document” refers to a data entity that describes a document including one or more text segments and subject to one or more controlling entities. A controlled text document, for example, may include a traditionally manually generated document that is required to satisfy one or more controlling rules and, due to the extensive set of controlling rules, is difficult to automatically generate using traditional generative techniques. For instance, a controlled text document may be associated with a plurality of different document templates, each corresponding to a different scenario for a particular controlled text document. Each template may include a plurality of controlled text fields that are case-specific and are required to satisfy controlling rules for a particular scenario. The controlling rules, for example, may require a certain reading level, a decision regarding a particular issue, particular supporting evidence for the decision, and/or the like.

As one example, a controlled text document may include an appeal decision letter for a responding to an appeal, such as a healthcare appeal regarding a medical claim decision. In such a case, the controlled text document may be structured according to a template corresponding to a type of healthcare appeal. The template may include a plurality of controlled fields that each contain information required by a healthcare regulatory authority, such as the Centers for Medicare & Medicaid Services. Moreover, the information provided in each of the controlled fields may be required to be elucidated at a sixth-grade reading level among other requirements designed to ensure a fairness of an appeal process (e.g., whether manually, or automatically completed).

In some embodiments, the term “controlled text fields” refers to a component of a controlled text document that is case specific and subject to one or more controlling rules. In some examples, a controlled text field may include a portion of a controlled text document that is dynamic relative to one or more other static portions (e.g., a template, etc.) of the controlled text document.

In some embodiments, the term “generative text request” refers to a message (e.g., an inter-service message, intra-service message, network message, etc.) that is descriptive of a request to generate a controlled text document and/or one or more portions thereof. In some examples, a generative text request may be initiated from a user device using a generative service plug-in. For example, a generative text request may be defined by an application programming interface (API) that is accessible, via the generative service plug-in, from a user interface of the user device. The API may communicatively connect the user device to a computing system configured to process a request to generate a controlled text document.

In some embodiments, a generative text request may include a request to generate a generative text document based on one or more input texts and/or other metadata associated with a topic associated with a desired controlled text document. The one or more input texts, for example, may include one or more request text fields that correspond to one or more controlled text fields of a desired controlled text document. In some examples, the other metadata may include one or more controlling rules for the desired controlled text document, such as one or more required pieces of information, a reading difficulty level, and/or the like. In some examples, the other metadata may include a reference to one or more evidentiary documents (e.g., case documentation for a healthcare appeal, etc.) for supporting and/or generating text for a controlled text field.

In some embodiments, the term “user interface” refers to an interface for a user device for managing one or more controlled text documents. In some examples, the user interface may include one or more document creation software tools configured to facilitate a creation, modification, and/or evaluation of a controlled text document. By way of example, one of the one or more document creation software tools may include a generative service plug-in.

In some embodiments, the term “generative service plug-in” refers to a software component that is configured to facilitate a generative text request. The generative service plug-in, for example, may include one or more portions of computer-readable media that, when executed by one or more processors, is configured to facilitate the generation of a generative text request from a user interface, provide the generative text request to a request tracking interface, and provide a response to the generative text request to the user interface. In some examples, the generative service plug-in may be configured to facilitate one or more other request messages described herein including, for example, one or more status requests, status responses, and/or the like.

In some embodiments, the term “request text fields” refers to a component of a generative text request. A request text field may include a segment of text manually generated for a particular case corresponding to a desired controlled text document. Each request text field, for example, may include a natural language text that reflects a decision for a particular case that corresponds to a controlled text field of a desired controlled text document and may not satisfy one or more controlling rules for a desired controlled text document.

As one example using healthcare appeal decision letter for illustration purposes, a desired controlled text document may include “Request Subject” and “We Decided” controlled text fields that each are subject to one or more different controlling rules. In such a case, the one or more request text fields may include (i) an “Appellant's Argument for Coverage” field including natural language text provided by an Appellant and (ii) a “Justification for Decision” field including natural language text provided by an appeal reviewer in response to the Appellant's arguments. In some examples, the “Appellant's Argument for Coverage” field may include text that corresponds to a “Request Subject” field of a desired controlled text document but does not conform with one or more controlling rules corresponding to the “Request Subject” field. In addition, or alternatively, the “Justification for Decision” field may include text that corresponds to a “We Decided” field of a desired controlled text document but does not conform with one or more controlling rules corresponding to the “We Decided” field.

In some embodiments, the term “document data store” refers to a data structure that describes data associated with controlled text document domain. A document data store may include any type (and any number) of data storage structures including, as examples, one or more linked lists, databases (e.g., relational databases, graph database, etc.), and/or the like.

In some embodiments, a document data store includes a plurality of historical text document data entities (e.g., nodes, data entries, etc.) for a controlled text document domain. Each historical text document data entity may include a historical text document and/or one or more document attributes. A historical text document, for example, may correspond to a previously written and/or generated controlled text document for a particular case (e.g., one document per case, etc.). In some examples, the one or more document attributes may include one or more of: (i) a case identifier, (ii) one or more historical text fields that each include text from a controlled text field of the historical text document, (iii) one or more historical request text fields that each include text from a historical generative text request corresponding to the historical text document, (iv) one or more document type classifications, (v) one or more contextual classifications corresponding to the historical text document, and/or (vi) one or more historical field embeddings corresponding to the one or more historical text fields.

By way of example, using the healthcare appeal decision letter example, the one or more historical text fields may include a “We Decided” text field, a “Request Subject” text field, and/or the like. In the same example, the historical request text fields may include an “Appellant's Argument for Coverage” text field, a “Justification for Decision” text field, and/or the like.

In some examples, the one or more document attributes may include a plurality of historical request-generative text field pairs that each describe a historical text field and a corresponding historical request text field. In some examples, the one or more document attributes may include one or more evaluation measures, such as a plurality of historical evaluation metrics and/or historical human (or inferred human) rating scores. In some examples, the one or more evaluation measures may correspond to each of the plurality of historical request-generative text field pairs,

In some embodiments, the term “initial document subset” refers to a subset of historical text documents (and/or one or more components of a corresponding historical text document data entity) extracted from a document data store. In some examples, an initial document subset may include a plurality of historical text documents that correspond to a particular document type. A document type may be defined using a plurality of categorical document type classifications. Each document type classification may describe a recipient category (e.g., provider vs. member, etc.), case timing subtype (e.g., post service, pre-service, etc.), and/or any other categorical feature of a controlled text document.

In some examples, each of the historical text documents may include one or more document type classifications. In addition, or alternatively, a generative text request may include one or more request type classifications. The one or more one or more request type classifications, for example, may be manually entered by a user and/or extracted from one or more case attributes associated with the generative text request.

An initial document subset may include a plurality of historical text documents that are each associated with a set of document type classifications corresponding to the one or more request type classifications.

In some embodiments, the term “refined document subset” refers to a subset of historical text documents (and/or one or more components of a corresponding historical text document data entity) extracted from an initial document subset. In some examples, a refined document subset may include a plurality of historical text documents that correspond to a particular contextual classification. For example, each of the historical text documents may include a contextual classification that may be compared to a contextual classification of the generative text request to identify the refined document subset.

In some examples, a contextual classification is generated for the generative text request based on the one or more text request fields. For instance, the contextual classification may be generated using a machine learning classifier model. The same machine learning classifier model may be previously used to generate one or more of a plurality of contextual classifications for the historical text documents of the document data store. In some examples, the refined document subset is generated by filtering the initial document subset to keep only those which have the same contextual classification as the generative text request.

In some embodiments, the term “contextual classification” refers to a data entity that describes a predetermined contextual scenario for a controlled text document. A contextual classification may include a data label that describes one of a plurality of defined scenarios for a controlled text document. For example, a contextual classification may identify a common request scenario, such as, using a healthcare appeal decision example, a dental scenario, a bundling scenario, a coding scenario, and/or any other scenario requirement a similar set of details to be communicated by a controlled text document. By way of example, a contextual classification may correspond to a set of similar controlling rules for generating a controlled text document.

In some embodiments, the term “machine learning classifier model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning classifier model may include any type of model configured, trained, and/or the like to generate a contextual classification for generative text request. A machine learning classifier model may include one or more of any type of machine learning model including one or more supervised, unsupervised, semi-supervised, reinforcement learning models, and/or the like. For instance, a machine learning classifier model may include a supervised model that may be trained using training data from a document data store. In some examples, a machine learning classifier model may include multiple models configured to perform one or more different stages of a classification process.

In some embodiments, a machine learning classifier model is trained to assign a contextual classification from a plurality of candidate contextual classifications to a generative text request based on one or more generative text fields of the generative text request. In some examples, the machine learning classifier model may be trained, using one or more supervisory training techniques (e.g., backpropagation of errors, etc.) to assign a contextual classification based on a plurality of historical contextual classifications respectively assigned to a plurality of historical text documents. By way of example, the machine learning classifier model may include one or more neural networks, convolutional neural networks, decision trees, random forest models, support vector machine, and/or the like, that is trained by optimizing a performance loss function, such as a softmax loss, cross-entropy loss, and/or the like, to improve a correspondence between contextual classifications output by the machine learning classifier model and one or more corresponding historical contextual classification (e.g., ground truths, etc.).

In some embodiments, the term “prompt document subset” refers to a subset of historical text documents (and/or one or more components of a corresponding historical text document data entity) extracted from a refined document subset. In some examples, a prompt document subset may include a threshold number of historical text documents from the refined document subset. The threshold number of historical text documents, for example, may be based on a related document threshold that identifies a threshold number of prompt examples for the generative model prompt.

In some embodiments, the prompt document subset is filtered from the refined document subset based on an embedding similarity between a request field embedding and a plurality of historical field embeddings corresponding to the refined document subset. For example, the prompt document subset may include a subset of documents that are associated with a greatest embedding similarity with the request field embedding. An embedding similarity, for example, may include a cosine similarity, dot product, Euclidian distance, and/or the like between two embeddings. In some examples, the prompt document subset may include a subset of documents that are associated with one or more historical field embeddings that have a smallest distance from the request field embedding.

In some examples, an embedding similarity score may be assigned to each historical text document of the refined document subset. The embedding similarity score may include an aggregate of a plurality of sub-similarity scores for each historical text document. For example, historical text document may be associated with a plurality of historical field embeddings including a historical field embedding for each of a plurality of historical text fields. By way of example, a sub-similarity score may be generated for each of the historical text fields based on an embedding comparison (e.g., cosine distance, etc.) between a historical field embedding and a corresponding request field embedding from the generative text request.

In some examples, greater efficiency in relevant document retrieval may be achieved by comparing embeddings to previously calculated hierarchical clusters of historical text embeddings and/or by using comparison to centroids of k-means clustering of historical text documents.

In some embodiments, a first portion of the prompt document subset is filtered from the refined document subset based on a greatest embedding similarity and a second portion may be filtered using one or more ancillary techniques to improve diversity of prompt examples. For example, retaining all historical text documents with a greatest similarity score may have a high probability of retaining only identical documents. To ensure diversity of examples, the refined document subset may be deduplicated to remove all identical historical text documents to keep only the unique N closest remaining historical text documents. In addition, or alternatively, a first portion (e.g., N/2) of the prompt document subset may include a set of unique documents with the greatest embedding similarity score with respect to the generative text request, and a second portion (e.g., N/2) may be randomly chosen from the embedding space to ensure diversity.

In some embodiments, the term “request field embedding” refers to an encoded data entity (e.g., one or more vectors, etc.) that corresponds to a request text field of a generative text request. A request field embedding may include any type of text embedding including Word2Vec embeddings, term frequency-inverse document frequency (TF-IDF) embeddings, bidirectional encoder representations from transformers (BERT) embeddings, and/or the like.

In some embodiments, the term “historical field embedding” refers to an encoded data entity (e.g., one or more vectors, etc.) that corresponds to a historical text field of a historical text document. A historical field embedding may include any type of text embedding including Word2Vec embeddings, TF-IDF embeddings, bidirectional encoder representations from transformers (BERT) embeddings, and/or the like.

In some embodiments, the term “machine learning embedding model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning embedding model may include any type of model configured, trained, and/or the like to generate an intermediate output, such as a field embedding, for a unit of text. A machine learning embedding model may include one or more of any type of machine learning model including one or more supervised, unsupervised, semi-supervised, reinforcement learning models, and/or the like. For instance, a machine learning embedding model may include a bidirectional transformer that may be trained using training data from the document data store to generate one or more domain specific embeddings for a controlled document domain.

In some embodiments, the term “generative model prompt” refers to an input for an LLM that is tailored to a particular generative text request. A generative model prompt, for example, may include a no-shot, few-shot, and/or any other type of LLM prompt that is configured to intelligently instruct the generation of generative text on behalf of a generative text request. In some examples, a generative model prompt may include a few-shot model prompt with a plurality of examples reflective of an acceptable generative text output. By way of example, the generative model prompt may include the prompt document subset as a plurality of acceptable generative text output.

In some examples, a generative model prompt may correspond to a particular controlled text field of a desired controlled text document. For instance, a separate prompt may be generated for each controlled text field of a desired controlled text document. Each prompt may include (i) a plurality of historical text fields from the prompt document subset that correspond to the particular controlled text field, (ii) a request text field corresponding to the particular controlled text field, and (iii) a prompt template corresponding to one or more controlling rules for the particular controlled text field.

In some embodiments, the term “large language model” or “LLM” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). An LLM may include any type of model configured, trained, and/or the like to generate natural language text in response to a textual prompt, such as the generative model prompts of the present disclosure. The LLM may include any type of LLM, such as a generative pre-trained transformer, and/or the like.

In some embodiments, the term “generative text field” refers to a data entity that describes natural language text output by an LLM in response to a generative model prompt. A generative text field may include text that is derived from a request text field and conforms with one or more controlling rules of a corresponding controlled text field.

In some embodiments, the term “generative text document” refers to a controlled text document that is generated using one or more generative text fields. For example, an LLM may be leveraged, using one or more different generative model prompts as described herein, to generate a generative text field for each controlled text field of a controlled text document. The generative text document may be generated by modifying the controlled text document to include the generative text fields at location designated by the controlled text fields of the controlled text document.

In some embodiments, the term “evaluation metric” refers to a data entity that describes a quality score for a generative text field. An evaluation metric may be generated, using one or more different natural language processing assessment techniques, based on a comparison between a generative text field and a corresponding manual text field, such as a request text field provided in a generative text request. In some examples, an evaluation metric may include a range of quality scores for a historical and/or generative text document. For example, an evaluation metric may include one or more of a Bilingual Evaluation Understudy (BLEU), a Recall-Oriented Understudy for Gisting Evaluation (ROUGE), a Metric for Evaluation of Translation with Explicit Ordering (METEOR), Perplexity, entity retention rate metric (e.g., proportion of recognized entities, proper nouns, numbers, etc. in the manual text field that are also present in the generative text field), and/or the like. In some examples, a plurality of evaluation metrics may be leveraged as features for a rating simulation model.

In some embodiments, the term “rating simulation model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A rating simulation model may include any type of model configured, trained, and/or the like to generate an inferred human rating score for one or more generative text fields. A rating simulation model may include one or more of any type of machine learning model including one or more supervised, unsupervised, semi-supervised, reinforcement learning models, and/or the like. For instance, a rating simulation model may include a supervised model that may be trained using training data from a document data store. In some examples, a rating simulation model may include multiple models configured to perform one or more different stages of a prediction process.

In some embodiments, a rating simulation model is trained to predict a human rating for a generative text field based on a plurality of evaluation metrics for the generative text field. In some examples, the rating simulation model may be trained, using one or more supervisory training techniques (e.g., backpropagation of errors, etc.), to generate an inferred human rating score based on a plurality of manual human rating scores respectively assigned to a plurality of historical text documents. By way of example, a rating simulation model may include one or more neural networks, convolutional neural networks, decision trees, random forest models, support vector machine, and/or the like, that is trained by optimizing a performance loss function, such as a softmax loss, cross-entropy loss, and/or the like, to improve a correspondence between an inferred human rating score output by the rating simulation model and one or more corresponding manual human rating scores (e.g., ground truths, etc.).

By way of example, manual labels that are indicative of manual human rating scores (e.g., include a number, range of number, etc. that are reflective of a subjective degree of quality) may be received for a subset of training historical text documents of the document data store. In some examples, the subset of training historical text documents may include a cross section of documents from the document data store that is representative of the entire dataset. This can be achieved, for example, by providing documents whose embeddings are uniformly distributed throughout the embedding space or providing a number of documents with uniformly distributed document type classifications and/or contextual classifications.

Using the subset of training historical text documents, the corresponding manual labels, and a plurality of evaluation metrics corresponding to each controllable text field of the subset of training historical text documents, the rating simulation model may be trained to map the plurality of evaluation metrics to a manually provided human rating. In some examples, feature filtering may be performed (e.g., on a defined interval) to remove one or more evaluation metrics that have poor correspondence to the manual human ratings. In some cases, the rating simulation model may be re-trained after the feature filtering operations.

In some embodiments, the term “inferred human rating score” is a data entity that describes a simulated score for a generative text field. An inferred human rating score may include a binary categorical value (e.g., acceptable/not-acceptable, etc.), multi-category categorical value (e.g., acceptable/not-acceptable, correct punctuation/missing punctuation, complete information/incomplete information, etc.), a numeric value (e.g., 6/10, 65%, etc.), and/or the like. An inferred human rating score may simulate a subject human rating for a model.

In some examples, a rating simulation model may be leveraged to generate inferred human rating scores for every historical text document (and/or controlled text fields thereof) that is not associated with a manual label. A quality of the generative text fields may be determined based on an aggregate (e.g., mean, median, etc.) of the plurality of inferred human rating scores. In some examples, multiple aggregate scores may be generated across multiple dimensions of human feedback. In some examples, the multiple aggregate scores may be translated into a single numeric rating (e.g., by creating a weighted sum of the scores, etc.).

In some embodiments, the LLM (and/or any other model of the present disclosure) may be trained based on the aggregate inferred human rating score. For example, the LLM may be trained to maximize the aggregate inferred human rating score. In some examples, the generative text fields output by the LLM may be evaluated and then stored (e.g., with an inferred human rating score) in the document data store. In such a case, the LLM may be iteratively retrained to continuously and automatically improve without a human in the loop.

### IV. Overview

Various embodiments of the present disclosure provide prompt engineering and quality assessment techniques that improve traditional generative text techniques, such as those that leverage LLMs. To do so, some embodiments of the present disclosure provide a multi-stage prompt engineering process to automatically generate a generative model prompt from a comprehensive data store. The multi-stage prompt engineering process may leverage a pipeline of machine learning and rule-based models that intelligently and incrementally filter prompt examples from a diverse set of documents within a document data store. These samples are leveraged to generate a generative model prompt that is specifically tailored to a particular text generation task. By doing so, generative model prompts may be automatically generated for a particular text generation task to alleviate technical challenges that traditionally hinder the performance of generative models. To ensure quality performance of the prompt engineering techniques, some embodiments of the present disclosure provide a quality assessment process that leverages a new rating simulation model and feature engineering techniques directly tailored for the rating simulation model to generate a simulated ranking of generative text output by a generative model using a particular prompt. As described herein, the specific features and training techniques leveraged for the rating simulation model enable a computer to perform a subjective task that is traditionally only achieved through human input. In this manner, generative text may be generated using prompts engineered for a specific use case and then automatically assessed to ensure text quality from a generative model. This, in turn, enables an improved generative text pipeline that directly addresses technical challenges within the realm of generative text techniques, such as inaccurate hallucinations, readability, among others.

In some embodiments, some of the prompt engineering techniques of the present disclosure are leveraged to generate text for a controlled document subject to one or more controlling rules. Traditionally, controlled documents are generated manually (i) to ensure compliance with various controlling rules and (ii) because the processing, time, and memory resources required to individually craft generative model prompts reduces the practicality of using generative models for such tasks. By using a multi-stage prompt engineering process, some of the techniques of the present disclosure may automate a prompt engineering process to enable the dynamic, case-specific generation of generative model prompts that account for controlling rules corresponding to a particular document, while providing targeted model examples for improving the readability and conciseness, among other textual improvements, to the resulting generative text. As described herein, these techniques may be extended to enable complex branching architectures that intelligently process requests for generative text corresponding to a diverse set of different constraints. By doing so, some of the techniques of the present disclosure may be practically applied to improve traditional computer-based text generation techniques. These improvements, in turn, enable the application of computer-based text generation techniques, such as LLMs, to a diverse set of problem spaces, such as controlled documentation, which is traditionally outside the scope of such techniques.

In some embodiments, some of the quality assessment techniques of the present disclosure enable the automatic quality assessment of generative text that is output using a generative text technique. Traditionally, the assessment of text is a manual process due to the subjective nature of the quality assessment task. While alterative metrics exist, these metrics are limited to specific facets of text and fail to provide a comprehensive substitute for a human quality rating. The requirement for human input significantly reduces the applicability of generative text techniques to small, individualized use cases. Using some of the techniques of the present disclosure, the applicability of generative text techniques may be expanded to large use cases without reducing the quality of generative text outputs by simulating a human rating for generative text. For example, using some of the quality assessment techniques of the present disclosure, a rating simulation model may be trained and implemented to generate an inferred human rating score for a generative text output. The rating simulation model, for example, may be trained to infer a human rating from a plurality of features engineered from generative text. These features, for example, may include one or more evaluation metrics that are traditionally limited to specific facets of a text-to-text comparison. By expanding these metrics, and other engineered features, to an inferred human rating, the rating simulation model may be trained to provide a comprehensive and subjective rating of generative text that is traditionally limited to human input. In this way, some of the quality assessment techniques of the present disclosure may automatically assess the traditionally subjective quality of generative text. As described herein, these assessment techniques may enable new loss metrics for improving generative text models, such as LLMs.

Examples of technologically advantageous embodiments of the present disclosure include: (i) prompt engineering techniques for automatically generating generative model prompts, (ii) text quality assessment techniques for assessing the quality of a generative text output, (iii) machine learning models, and training techniques thereof, for generating and implementing a rating simulation model, among other aspects of the present disclosure. Other technical improvements and advantages may be realized by one of ordinary skill in the art.

### V. Example System Operations

As indicated, various embodiments of the present disclosure make important technical contributions to generative text techniques. In particular, systems and methods are disclosed herein that implement prompt engineering and quality assessment techniques to improve machine learning model performance with respect to text generation tasks. By doing so, generative text models may be improved to expand the applicability of generative text techniques to diverse and controlled use cases. This, in turn, may enable the use of generative text models for controlled documentation that is traditionally outside the scope of such models.

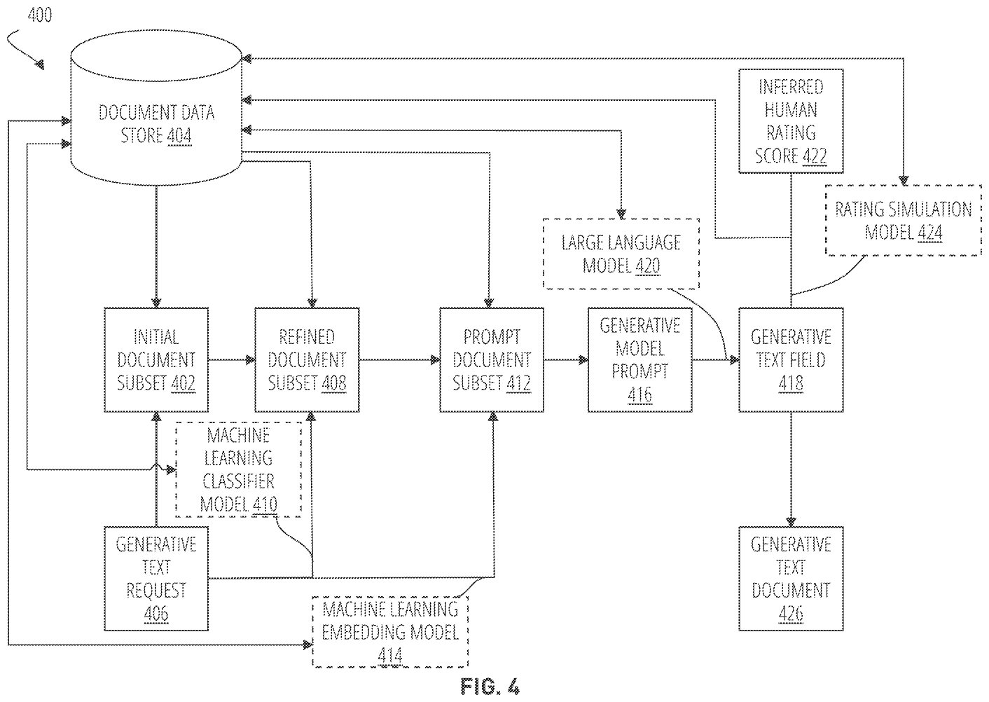

FIG. 4 is a dataflow diagram 400 showing example data structures and modules for generating a generative text document in accordance with some embodiments discussed herein. The dataflow diagram 400, for example, illustrates a multi-stage text processing pipeline for automatically engineering a generative model prompt 416 for a LLM 420 that is tailored to a particular use case of a diverse set of use cases. As described herein, the multi-stage text processing pipeline may include a plurality of connected models that are collectively configured to process a generative text request 406 and, in response to the generative text request 406, generate a generative text document 426. Unlike traditional language processing techniques, the multi-stage text processing pipeline is configured to automatically generate a generative model prompt 416 for one or more generative text fields 418 of the generative text document 426 by incrementally filtering documents from a document data store 404. In this way, the multi-stage text processing pipeline may save processing resources and time, while improving the coverage of traditional LLMs to a diverse set of use cases.

In some embodiments, an initial document subset 402 is identified, from a document data store 404, and for a generative text request 406. The generative text request 406 may include a request to generate a generative text document 426 based on one or more request text fields. In some examples, the generative text request 406 may include a category field that identifies a predefined category type corresponding to the one or more request text fields. In such a case, the initial document subset 402 may include a plurality of historical text documents that correspond to the predefined category type. The generative text request 406 may correspond to controlled text document.

In some embodiments, a controlled text document is a data entity that describes a document including one or more text segments and subject to one or more controlling entities. A controlled text document, for example, may include a traditionally manually generated document that is required to satisfy one or more controlling rules and, due to the extensive set of controlling rules, is difficult to automatically generate using traditional generative techniques. For instance, a controlled text document may be associated with a plurality of different document templates, each corresponding to a different scenario for a particular controlled text document. Each template may include a plurality of controlled text fields that are case-specific and are required to satisfy controlling rules for a particular scenario. The controlling rules, for example, may require a certain reading level, a decision regarding a particular issue, particular supporting evidence for the decision, and/or the like.

As one example, a controlled text document may include an appeal decision letter for a responding to an appeal, such as a healthcare appeal regarding a medical claim decision. In such a case, the controlled text document may be structured according to a template corresponding to a type of healthcare appeal. The template may include a plurality of controlled fields that each contain information required by a healthcare regulatory authority, such as the Centers for Medicare & Medicaid Services. Moreover, the information provided in each of the controlled fields may be required to be elucidated at a sixth-grade reading level among other requirements designed to ensure a fairness of an appeal process (e.g., whether manually, or automatically completed).

In some embodiments, a controlled text field is a component of a controlled text document that is case specific and subject to one or more controlling rules. In some examples, a controlled text field may include a portion of a controlled text document that is dynamic relative to one or more other static portions (e.g., a template, etc.) of the controlled text document.

In some embodiments, the generative text request 406 is a message (e.g., an inter-service message, intra-service message, network message, etc.) that is descriptive of a request to generate a controlled text document and/or one or more portions thereof. In some examples, the generative text request 406 may be initiated from a user device using a generative service plug-in, as described in further detail herein. For example, the generative text request 406 may be defined by an API that is accessible, via the generative service plug-in, from a user interface of the user device. The API may communicatively connect the user device to a computing system and/or service configured to process a request to generate a controlled text document.

In some embodiments, the generative text request 406 may include a request to generate a generative text document 426 based on one or more input texts and/or other metadata associated with a topic associated with a desired controlled text document. The one or more input texts, for example, may include one or more request text fields that correspond to one or more controlled text fields of a desired controlled text document. In some examples, the other metadata may include one or more controlling rules for the desired controlled text document, such as one or more required pieces of information, a reading difficulty level, and/or the like. In some examples, the other metadata may include a reference to one or more evidentiary documents (e.g., case documentation for a healthcare appeal, etc.) for supporting and/or generating text for a controlled text field.

In some embodiments, a contextual classification is generated for the one or more request text fields. The contextual classification, for example, may be generated using a machine learning classifier model 410. In some examples, the document data store 404 includes a plurality of historical text documents and a plurality of contextual classification labels respectively corresponding to the plurality of historical text documents. In some examples, the machine learning classifier model 410 may be previously trained using the plurality of contextual classification labels as a plurality of ground truths.

In some embodiments, the request text fields are a component of a generative text request 406. A request text field may include a segment of text manually generated for a particular case corresponding to a desired controlled text document. Each request text field, for example, may include a natural language text that reflects a decision for a particular case that corresponds to a controlled text field of a desired controlled text document and may not satisfy one or more controlling rules for a desired controlled text document.

As one example using healthcare appeal decision letter for illustration purposes, a desired controlled text document may include “Request Subject” and “We Decided” controlled text fields that each are subject to one or more different controlling rules. In such a case, the one or more request text fields may include (i) an “Appellant's Argument for Coverage” field including natural language text provided by an Appellant and (ii) a “Justification for Decision” field including natural language text provided by an appeal reviewer in response to the Appellant's arguments. In some examples, the “Appellant's Argument for Coverage” field may include text that corresponds to a “Request Subject” field of a desired controlled text document but does not conform with one or more controlling rules corresponding to the “Request Subject” field. In addition, or alternatively, the “Justification for Decision” field may include text that corresponds to a “We Decided” field of a desired controlled text document but does not conform with one or more controlling rules corresponding to the “We Decided” field.

In some embodiments, the document data store 404 is a data structure that describes data associated with controlled text document domain. The document data store 404 may include any type (and any number) of data storage structures including, as examples, one or more linked lists, databases (e.g., relational databases, graph database, etc.), and/or the like.

In some embodiments, the document data store 404 includes a plurality of historical text document data entities (e.g., nodes, data entries, etc.) for a controlled text document domain. Each historical text document data entity may include a historical text document and/or one or more document attributes. A historical text document, for example, may correspond to a previously written and/or generated controlled text document for a particular case (e.g., one document per case, etc.). In some examples, the one or more document attributes may include one or more of: (i) a case identifier, (ii) one or more historical text fields that each include text from a controlled text field of the historical text document, (iii) one or more historical request text fields that each include text from a historical generative text request corresponding to the historical text document, (iv) one or more document type classifications, (v) one or more contextual classifications corresponding to the historical text document, and/or (vi) one or more historical field embeddings corresponding to the one or more historical text fields.

By way of example, using the healthcare appeal decision letter example, the one or more historical text fields may include a “We Decided” text field, a “Request Subject” text field, and/or the like. In the same example, the historical request text fields may include an “Appellant's Argument for Coverage” text field, a “Justification for Decision” text field, and/or the like.

In some examples, the one or more document attributes may include a plurality of historical request-generative text field pairs that each describe a historical text field and a corresponding historical request text field. In some examples, the one or more document attributes may include one or more evaluation measures, such as a plurality of historical evaluation metrics and/or historical human (or inferred human) rating scores. In some examples, the one or more evaluation measures may correspond to each of the plurality of historical request-generative text field pairs,

In some embodiments, the initial document subset 402 is a subset of historical text documents (and/or one or more components of a corresponding historical text document data entity) extracted from the document data store 404. In some examples, the initial document subset 402 may include a plurality of historical text documents that correspond to a particular document type. A document type may be defined using a plurality of categorical document type classifications. Each document type classification may describe a recipient category (e.g., provider vs. member, etc.), case timing subtype (e.g., post service, pre-service, etc.), and/or any other categorical feature of a controlled text document.

In some examples, each of the historical text documents may include one or more document type classifications. In addition, or alternatively, the generative text request 406 may include one or more request type classifications. The one or more one or more request type classifications, for example, may be manually entered by a user and/or extracted from one or more case attributes associated with the generative text request 406.

The initial document subset 402 may include a plurality of historical text documents that are each associated with a set of document type classifications corresponding to the one or more request type classifications.

In some embodiments, a refined document subset 408 is identified from the initial document subset 402 based on the contextual classification.

In some embodiments, the refined document subset 408 is a subset of historical text documents (and/or one or more components of a corresponding historical text document data entity) extracted from the initial document subset 402. In some examples, the refined document subset 408 may include a plurality of historical text documents that correspond to a particular contextual classification. For example, each of the historical text documents may include a contextual classification that may be compared to a contextual classification of the generative text request 406 to identify the refined document subset 408.

In some examples, a contextual classification is generated for the generative text request 406 based on the one or more text request fields. For instance, the contextual classification may be generated using a machine learning classifier model 410. The same machine learning classifier model 410 may be previously used to generate one or more of a plurality of contextual classifications for the historical text documents of the document data store 404. In some examples, the refined document subset 408 is generated by filtering the initial document subset 402 to keep only those which have the same contextual classification as the generative text request 406.

In some embodiments, the contextual classification is a data entity that describes a predetermined contextual scenario for a controlled text document. A contextual classification may include a data label that describes one of a plurality of defined scenarios for a controlled text document. For example, a contextual classification may identify a common request scenario, such as, using a healthcare appeal decision example, a dental scenario, a bundling scenario, a coding scenario, and/or any other scenario requirement a similar set of details to be communicated by a controlled text document. By way of example, a contextual classification may correspond to a set of similar controlling rules for generating a controlled text document.

In some embodiments, the machine learning classifier model 410 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning classifier model 410 may include any type of model configured, trained, and/or the like to generate a contextual classification for generative text request 406. The machine learning classifier model 410 may include one or more of any type of machine learning model including one or more supervised, unsupervised, semi-supervised, reinforcement learning models, and/or the like. For instance, the machine learning classifier model 410 may include a supervised model that may be trained using training data from the document data store 404. In some examples, the machine learning classifier model 410 may include multiple models configured to perform one or more different stages of a classification process.

In some embodiments, the machine learning classifier model 410 is trained to assign a contextual classification from a plurality of candidate contextual classifications to a generative text request 406 based on one or more generative text fields of the generative text request 406. In some examples, the machine learning classifier model 410 may be trained, using one or more supervisory training techniques (e.g., backpropagation of errors, etc.) to assign a contextual classification based on a plurality of historical contextual classifications respectively assigned to a plurality of historical text documents. By way of example, the machine learning classifier model 410 may include one or more neural networks, convolutional neural networks, decision trees, random forest models, support vector machine, and/or the like, that is trained by optimizing a performance loss function, such as a softmax loss, cross-entropy loss, and/or the like, to improve a correspondence between contextual classifications output by the machine learning classifier model 410 and one or more corresponding historical contextual classification (e.g., ground truths, etc.).

In some embodiments, one or more request field embeddings respectively corresponding to the one or more request text fields may be generated using a machine learning embedding model 414. In some examples, the document data store 404 includes a plurality of historical text documents and a plurality of historical field embeddings respectively corresponding to the plurality of historical text documents. The prompt document subset 412 may be based on a plurality of embedding similarity scores between the one or more request field embeddings and the plurality of historical field embeddings.

In some embodiments, the request field embedding is an encoded data entity (e.g., one or more vectors, etc.) that corresponds to a request text field of a generative text request 406. A request field embedding may include any type of text embedding including Word2Vec embeddings, TF-IDF embeddings, BERT embeddings, and/or the like.

In some embodiments, the historical field embeddings are encoded data entities (e.g., one or more vectors, etc.) that corresponds to a historical text field of a historical text document. A historical field embedding may include any type of text embedding including Word2Vec embeddings, TF-IDF embeddings, BERT embeddings, and/or the like.

In some embodiments, the machine learning embedding model 414 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning embedding model 414 may include any type of model configured, trained, and/or the like to generate an intermediate output, such as a field embedding, for a unit of text. The machine learning embedding model 414 may include one or more of any type of machine learning model including one or more supervised, unsupervised, semi-supervised, reinforcement learning models, and/or the like. For instance, the machine learning embedding model 414 may include a bidirectional transformer that may be trained using training data from the document data store 404 to generate one or more domain specific embeddings for a controlled document domain.

In some embodiments, a prompt document subset 412 is identified from the refined document subset 408 based on the one or more request field embeddings. In some examples, the prompt document subset 412 may be based on a related document threshold (e.g., 2, 5, 10, 15, 100, etc.) indicative of (e.g., including a static and/or dynamically set numeric value, etc.) a threshold number of prompt examples for the generative model prompt 416. A first portion of the prompt document subset 412 may include one or more first historical text documents that are associated with one or more highest embedding similarity scores from the plurality of embedding similarity scores. In some examples, a second portion of the prompt document subset 412 may include one or more second historical text documents that are randomly sampled from the refined document subset 408.

In some embodiments, the prompt document subset 412 is a subset of historical text documents (and/or one or more components of a corresponding historical text document data entity) extracted from a refined document subset 408. In some examples, the prompt document subset 412 may include a threshold number of historical text documents from the refined document subset 408. The threshold number of historical text documents, for example, may be based on a related document threshold that identifies a threshold number of prompt examples for the generative model prompt 416.

In some embodiments, the prompt document subset 412 is filtered from the refined document subset 408 based on an embedding similarity between a request field embedding and a plurality of historical field embeddings corresponding to the refined document subset 408. For example, the prompt document subset 412 may include a subset of documents that are associated with a greatest embedding similarity with the request field embedding. An embedding similarity, for example, may include a cosine similarity, dot product, Euclidian distance, and/or the like between two embeddings. In some examples, the prompt document subset 412 may include a subset of documents that are associated with one or more historical field embeddings that have a smallest distance from the request field embedding.

In some examples, an embedding similarity score may be assigned to each historical text document of the refined document subset 408. The embedding similarity score may include an aggregate of a plurality of sub-similarity scores for each historical text document. For example, historical text document may be associated with a plurality of historical field embeddings including a historical field embedding for each of a plurality of historical text fields. By way of example, a sub-similarity score may be generated for each of the historical text fields based on an embedding comparison (e.g., cosine distance, etc.) between a historical field embedding and a corresponding request field embedding from the generative text request 406.

In some examples, greater efficiency in relevant document retrieval may be achieved by comparing embeddings to previously calculated hierarchical clusters of historical text embeddings and/or by using comparison to centroids of k-means clustering of historical text documents.

In some embodiments, a first portion of the prompt document subset 412 is filtered from the refined document subset 408 based on a greatest embedding similarity and a second portion may be filtered using one or more ancillary techniques to improve diversity of prompt examples. For example, retaining all historical text documents with a greatest similarity score may have a high probability of retaining only identical documents. To ensure diversity of examples, the refined document subset 408 may be deduplicated to remove all identical historical text documents to keep only the unique N closest remaining historical text documents. In addition, or alternatively, a first portion (e.g., N/2) of the prompt document subset 412 may include a set of unique documents with the greatest embedding similarity score with respect to the generative text request 406, and a second portion (e.g., N/2) may be randomly chosen from the embedding space to ensure diversity.

In some embodiments, one or more generative text fields 418 are generated using a generative model prompt 416. For example, the generative text field 418 may be generated using an LLM 420. For instance, the generative model prompt 416 may be input to the LLM 420 to receive the generative text fields 418. In some examples, the generative model prompt 416 is based on the prompt document subset 412 and the one or more request text fields.

In some embodiments, the generative model prompt 416 is an input for the LLM 420 that is tailored to a particular generative text request 406. The generative model prompts 416, for example, may include a no-shot, few-shot, and/or any other type of LLM prompt that is configured to intelligently instruct the generation of generative text on behalf of a generative text request 406. In some examples, the generative model prompt 416 may include a few-shot model prompt with a plurality of examples reflective of an acceptable generative text output. By way of example, the generative model prompt 416 may include the prompt document subset 412 as a plurality of acceptable generative text outputs.

In some examples, the generative model prompt 416 may correspond to a particular controlled text field of a desired controlled text document. For instance, a separate prompt may be generated for each controlled text field of a desired controlled text document. Each prompt may include (i) a plurality of historical text fields from the prompt document subset 412 that correspond to the particular controlled text field, (ii) a request text field corresponding to the particular controlled text field, and (iii) a prompt template corresponding to one or more controlling rules for the particular controlled text field.

In some embodiments, the LLM 420 or “LLM” is a data entity that describes parameters, hyper-parameters, and/or defined operations of a rules-based and/or machine learning model (e.g., model including at least one of one or more rule-based layers, one or more layers that depend on trained parameters, coefficients, and/or the like). The LLM 420 may include any type of model configured, trained, and/or the like to generate natural language text in response to a textual prompt, such as the generative model prompts 416 of the present disclosure. The LLM 420 may include any type of LLM, such as a generative pre-trained transformer, and/or the like.

In some embodiments, the generative text field 418 is a data entity that describes natural language text output by the LLM 420 in response to the generative model prompt 416. A generative text field 418 may include text that is derived from a request text field and conforms with one or more controlling rules of a corresponding controlled text field.

In some embodiments, a request response is provided in response to the generative text request 406. The request response, for example, may include a generative text document 426 that is based on the one or more generative text fields 418.

In some embodiments, the generative text document 426 is a controlled text document that is generated using one or more generative text fields 418. For example, the LLM 420 may be leveraged, using one or more different generative model prompts as described herein, to generate a generative text field 418 for each controlled text field of a controlled text document. The generative text document 426 may be generated by modifying the controlled text document to include the generative text fields 418 at locations designated by the controlled text fields of the controlled text document.

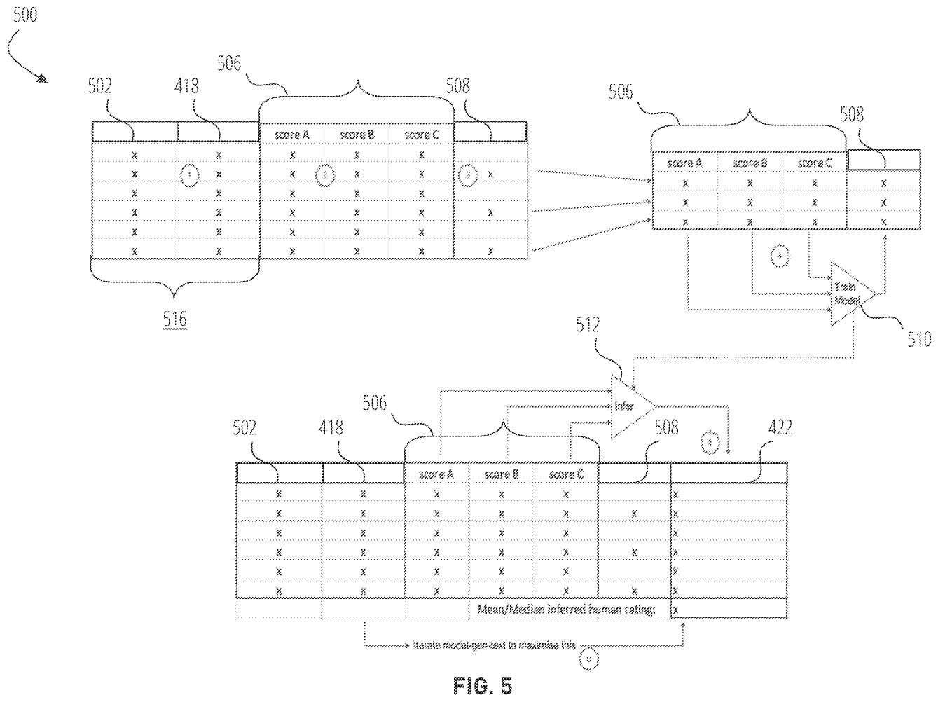

In some embodiments, the generative text fields 418 are evaluated to identify a quality level of the generative text fields 418 and/or generative text document 426. By doing so, a generative text document 426 and/or one or more generative text field 418 thereof may be automatically analyzed to detect and prevent one or more abnormalities, such as inaccurate hallucinations, lack of readability, and/or the like, that may be attributed to the LLM 420. By way of example, the quality level may be automatically generated using a rating simulation model 424 that is trained using the document data store 404. In some examples, the rating simulation model 424 may be trained to generate an inferred human rating score 422 to simulate a manual review process without human input. An example of a rating simulation model 424 is described in further detail with reference to FIG. 5.

FIG. 5 is an operational example 500 of a rating simulation model in accordance with some embodiments discussed herein. As depicted, a rating simulation model 510 may be trained to generate an inferred human rating score 422 based on a plurality of evaluation metrics 506. Once trained, a plurality of evaluation metrics 506 may be generated for the LLM based on a comparison between the one or more request text fields 502 and one or more generative text fields 418. Using the trained rating simulation model 512, an inferred human rating score 422 may be generated for the one or more generative text fields 418 based on the plurality of evaluation metrics. In some examples, the LLM may be trained to maximize the inferred human rating score 422.

In some embodiments, the rating simulation model 510 is trained using a plurality of historical request-generative text field pairs 516. Each historical request-generative text field pair of the plurality of historical request-generative text field pairs 516 may be associated with a plurality of historical evaluation metrics 506. In some examples, one or more of the historical request-generative text field pairs 516 may be associated with a manual label 508 indicative of a historical human rating score (e.g., 0.9, 90%, 9/10, etc.). The plurality of evaluation metrics 506 any type of evaluation metric including, as examples, a Bilingual Evaluation Understudy (BLEU) metric, a Recall-Oriented Understudy for Gisting Evaluation (ROUGE) metric, and a Metric for Evaluation of Translation with Explicit Ordering (METEOR) metric.

In some embodiments, the evaluation metrics 506 are data entities that describe a quality score for a generative text field 418. An evaluation metric 506 may be generated, using one or more different natural language processing assessment techniques, based on a comparison between a generative text field 418 and a corresponding manual text field, such as a request text field 502 provided in a generative text request. In some examples, an evaluation metric 506 may include a range of quality scores for a historical and/or generative text document. For example, an evaluation metric may include one or more of a BLEU, ROUGE, METEOR, Perplexity, entity retention rate metric (e.g., proportion of recognized entities, proper nouns, numbers, etc. in the manual text field that are also present in the generative text field), and/or the like. In some examples, a plurality of evaluation metrics 506 may be leveraged as features for the rating simulation model (e.g., an untrained rating simulation model 510 and/or a trained rating simulation model 512).

In some embodiments, the trained rating simulation model 512 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The trained rating simulation model 512 may include any type of model configured, trained, and/or the like to generate an inferred human rating score 422 for one or more generative text fields 418. The trained rating simulation model 512 may include one or more of any type of machine learning model including one or more supervised, unsupervised, semi-supervised, reinforcement learning models, and/or the like. For instance, the trained rating simulation model 512 may include a supervised model that may be trained using training data from a document data store. In some examples, the trained rating simulation model 512 may include multiple models configured to perform one or more different stages of a prediction process.

In some embodiments, the trained rating simulation model 512 is trained to predict a human rating for a generative text field 418 based on a plurality of evaluation metrics 506 for the generative text field 418. In some examples, the trained rating simulation model 512 may be trained, using one or more supervisory training techniques (e.g., backpropagation of errors, etc.), to generate an inferred human rating score 422 based on a plurality of manual labels 508 (e.g., manual human rating scores, etc.) respectively assigned to a plurality of historical text documents. By way of example, the trained rating simulation model 512 may include one or more neural networks, convolutional neural networks, decision trees, random forest models, support vector machine, and/or the like, that is trained by optimizing a performance loss function, such as a softmax loss, cross-entropy loss, and/or the like, to improve a correspondence between an inferred human rating score 422 output by the rating simulation model 510 and one or more corresponding manual labels 508 (e.g., manual human rating scores, etc.) that may be used as ground truths.

By way of example, manual labels 508 indicative of (e.g., including a numeric value, etc.) manual human rating scores may be received for a subset of training historical text documents of the document data store. In some examples, the subset of training historical text documents may include a cross section of documents from the document data store that is representative of the entire dataset. This can be achieved, for example, by providing documents whose embeddings are uniformly distributed throughout the embedding space or providing a number of documents with uniformly distributed document type classification s and/or contextual classifications.

Using the subset of training historical text documents, the corresponding manual labels 508, and a plurality of evaluation metrics 506 corresponding to each controllable text field of the subset of training historical text documents, the rating simulation model 510 may be trained to map the plurality of evaluation metrics to a manually provided human rating. In some examples, feature filtering may be performed (e.g., on a defined interval) to remove one or more evaluation metrics that have poor correspondence to the manual human ratings. In some cases, the trained rating simulation model 512 may be re-trained after the feature filtering operations.

In some embodiments, the inferred human rating score 422 is a data entity that describes a simulated score for a generative text field 418. An inferred human rating score 422 may include a binary categorical value (e.g., acceptable/not-acceptable, etc.), multi-category categorical value (e.g., acceptable/not-acceptable, correct punctuation/missing punctuation, complete information/incomplete information, etc.), a numeric value (e.g., 6/10, 65%, etc.), and/or the like. An inferred human rating score 422 may simulate a subject human rating for a model.

In some examples, the trained rating simulation model 512 may be leveraged to generate inferred human rating scores 422 for every historical text document (and/or controlled text fields thereof) that is not associated with a manual label 508. A quality of the generative text fields 418 may be determined based on an aggregate (e.g., mean, median, etc.) of the plurality of inferred human rating scores 422. In some examples, multiple aggregate scores may be generated across multiple dimensions of human feedback. In some examples, the multiple aggregate scores may be translated into a single numeric rating (e.g., by creating a weighted sum of the scores, etc.).

In some embodiments, an LLM (and/or any other model of the present disclosure) may be trained based on the aggregate inferred human rating score. For example, the LLM may be trained to maximize the aggregate inferred human rating score. In some examples, the generative text fields 418 output by the LLM may be evaluated and then stored (e.g., with an inferred human rating score 422) in the document data store. In such a case, the LLM may be iteratively retrained to continuously and automatically improve without a human in the loop.

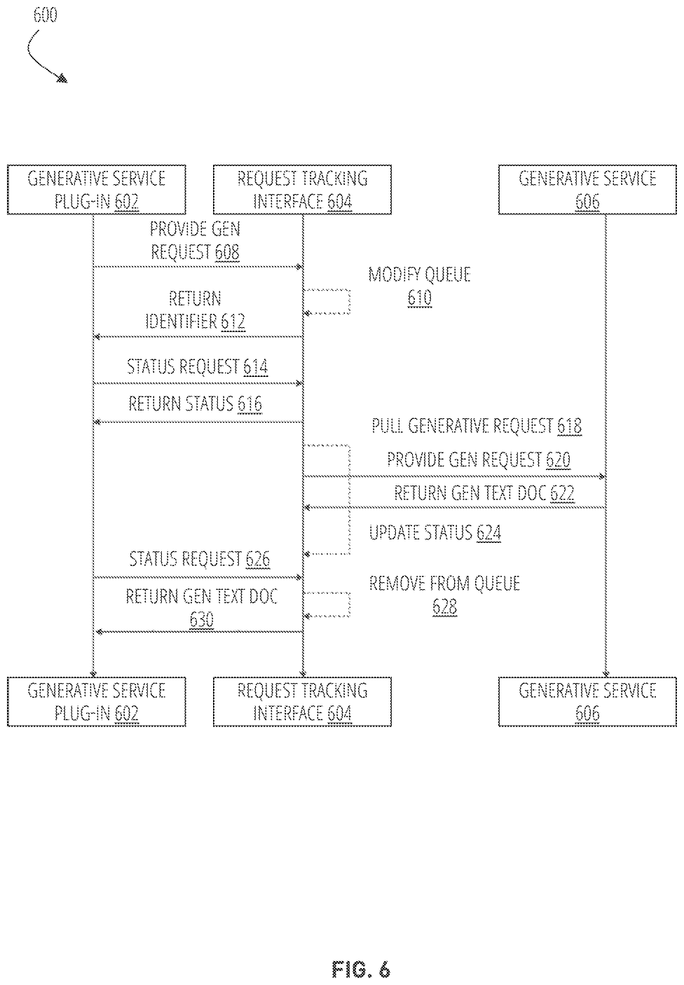

In some embodiments, one or more generative text fields 418, and/or a generative text document based thereon, is provided to a user in response to an inferred human rating score 422 achieving a quality threshold. For example, a generative text request may be generated and/or provided to a backend service, such as a generative service, for initiating one or more operations of the present disclosure. In some examples, the generative text request may be provided from a client device to the backend service via a generative service plug-in. The generative service may return one or more generative text fields 418 and/or a generative text document in the event that the data objects achieve the quality threshold. In this manner, one or more generative text fields 418 and/or a generative text document may be reliably generated through a plurality of entity-to-entity interactions. An example of such interactions is described in further detail with reference to FIG. 6.

FIG. 6 is an activity diagram 600 showing example entity to entity interactions in accordance with some embodiments discussed herein. As depicted, a plurality of entity-to-entity interaction may be performed through network communications between a generative service plug-in 602, a request tracking interface 604, and/or a generative service 606. For instance, at 608, the generative service plug-in 602 may initiate a generative text request. At 610, the request tracking interface 604 may receive the generative text request. For example, the generative text request may be received, via an API call, which is initiated from the generative service plug-in 602 associated with a user device.

In some embodiments, the generative service plug-in 602 is a software component that is configured to facilitate a generative text request. The generative service plug-in 602, for example, may include one or more portions of computer-readable media that, when executed by one or more processors, is configured to facilitate the generation of a generative text request from a user interface, provide the generative text request to a request tracking interface 604, and provide a response to the generative text request to the user interface. In some examples, the generative service plug-in 602 may be configured to facilitate one or more other request messages described herein including, for example, one or more status requests, status responses, and/or the like.

In some embodiments, the user interface is rendered one a display of a user device. The user interface, for example, may include a user interface of a software application configured for managing one or more controlled text documents. In some examples, the user interface may include one or more document creation software tools configured to facilitate a creation, modification, and/or evaluation of a controlled text document. By way of example, one of the one or more document creation software tools may include the generative service plug-in 602.

At 612, in response to the API call, a request identifier may be provided for the generative text request. For instance, the request tracking interface 604 may add the generative text request to an internal processing queue, generate a request identifier for the generative text request, and return the request identifier to the generative service plug-in 602. In some examples, the generative text request may be stored with the request identifier in the processing queue.

In some embodiments, a request identifier includes a sequence of alpha-numeric, numeric, and/or the like, characters. In some examples, the request identifier may include a randomly generated sequence of alpha-numeric characters. In addition, or alternatively, the request identifier may include a sequence of alpha-numeric characters that is incremented by a predetermined value for each new generative text request. In some examples, the request identifier may include one or more identifiers that are based on information provided in a generative text request and/or a user associated with the request. Regardless of the form, the request identifier may be configured to identify a generative text request to both a user device (and/or generative service plug-in 602, etc.) and a request tracking interface 604.

In some embodiments, the request tracking interface 604 is an intermediary service configured to facilitate communication between a user device (e.g., generative service plug-ins 602, etc.) and a generative service 606. The request tracking interface 604, for example, may include an API between the generative service plug-in 602 and the generative service 606. As described, herein the request tracking interface 604 may be configured to store generative text requests in a processing queue to manage a rate at which requests are provided to the generative service 606. By doing so, this request tracking interface 604 may prevent overloading the generative service 606. Moreover, the resulting generative text document (and/or generative text fields thereof) may be stored in a completed queue for retrieval by the generative service plug-in 602. By storing the resulting generative text document (and/or generative text fields thereof) in a completed queue-rather than automatically returning the outputs to the generative service plug-in 602-the request tracking interface 604 may allow for the selective retrieval of information at a user device. This addresses bandwidth constraints and limited procession resources of a user device by delaying the return of the generative text document (and/or generative text fields thereof) until the device is ready to receive the data.

At 614, the generative service plug-in 602 may initiate a status request to the request tracking interface 604. The status request may include the request identifier. For example, a status request may include a network message, an API call, and/or the like, that in includes a request for a current status of a generative text request. To limit the bandwidth constraints of sending the status request, the status request may identify the generative text request using the request identifier.

At 616, the request tracking interface 604 may return a request status to the generative service plug-in 602. In the event that the generative text request is still in the processing queue, the request status may include the request identifier and a pending request status. In some examples, the pending request status may describe a forecasted wait time for the generative text request,

At 618, the generative text request may be pulled from the processing queue and, at 620, the request tracking interface 604 may provide the generative text request to the generative service 606.

In some embodiments, the generative service 606 includes one or more computer processes (e.g., subroutines, etc.) that are configured to implement one or more operations of the present disclosure to generate one or more generative text fields and/or a generative text document in response to a generative text request. The generative service 606 may include a local computing service that may be instantiated at a user device. In addition, or alternatively, the generative service may include a remote service that is implemented by a remote computing system, such as a cloud-based server, a remote server, and/or the like. In some examples, the generative service 606 may include a third-party service, such as OpenAI and/or another large language modelling service.

At 622, the request tracking interface 604 may receive one or more generative text fields and/or a generative text document from the generative service 606. The request tracking interface 604 may store the generative text document and/or generative text fields with the request identifier in a completed queue.

At 624, the request tracking interface 604 may update the request status for the generative text request. At 626, the request tracking interface 604 may receive another status request comprising the request identifier. At 628 and 630, in response to the status request, the request tracking interface 604 may remove the generative text request from the completed queue and provide the generative text document and/or the one or more generative text fields to the generative service plug-in 602 and/or a user device thereof.

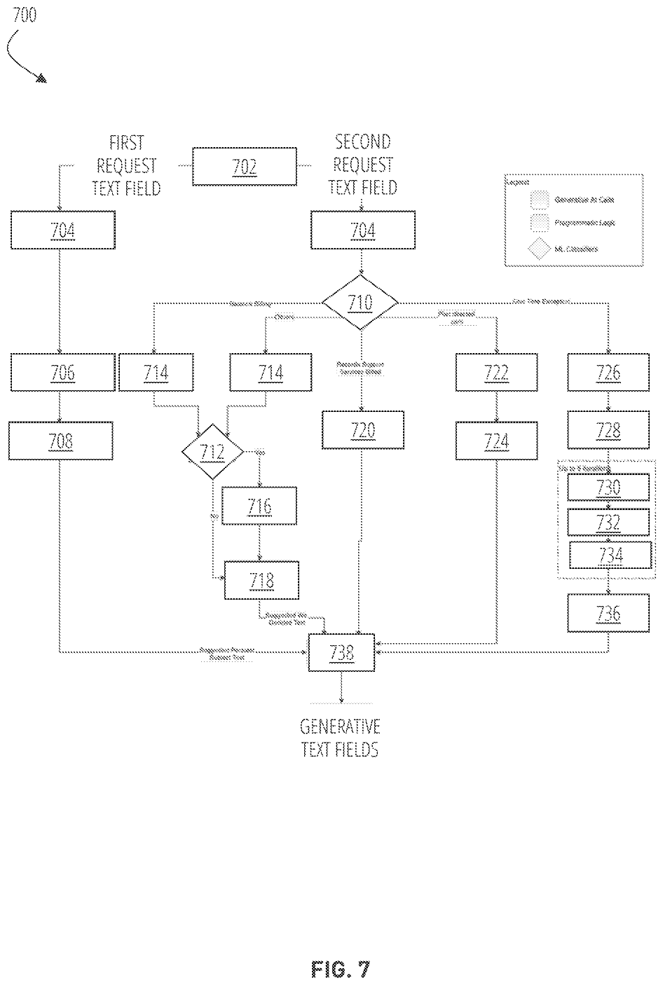

In this manner, a plurality of computing entities may collectively generate and process a generative text request. In some examples, the generative text request may be processed using a single technique, such as the prompt engineering and quality assessment techniques described with reference to FIGS. 4 and 5. In addition, or alternatively, for more complex use cases, the techniques of the present disclosure may be expanded to a branched processing architecture in which each generative text field is generated in accordance with a branch of the branched processing architecture based on the individual attributes associated with the generative text field. An example of a branched processing architecture is described in further detail with reference to FIG. 7.

FIG. 7 is an operational example 700 of a branched processing architecture in accordance with some embodiments discussed herein. As depicted, the branched processing architecture may include a plurality of processing branches that are each configured to generate a generative text field in the event that one or more branch criteria is met for the particular branch. The first branch criteria may define a request text field that corresponds to a particular branch of the branched processing architecture. For example, after receiving a generative text request at 702, a first portion of the generative text request that corresponds to a first request text field may be provided to a first field-specific branch of the branched processing architecture. In addition, or alternatively, a second portion of the generative text request that corresponds to a second request text field may be provided to a second field-specific branch of the branched processing architecture. At 704, in each field-specific branch, a different prompt document subset may be identified, using some of the techniques of the present disclosure, for each request text field of the generative text request.

With reference to the first field-specific branch, at 706, in the first field-specific branch, a generative model prompt may be generated for the first request text field using the prompt document subset. At 708, the generative model prompt may be provided as input to a LLM to receive a generative text field corresponding to the first request text field.

Turning to the second field-specific branch, at 710, the second portion of the generative text request may be routed to a different sub-branch based on one or more criteria that may be defined based on one or more controlling rules for a controlled text field corresponding to the second request text field. For example, the one or more controlling rules may specify one or more different rules based on an outcome described by the second request text field. In such a case, at 710, the branched processing architecture may identify an outcome described by the second request text field and route the second portion of the generative text request to a different outcome-specific sub-branch of the branched processing architecture.

With reference to a first and second outcome-specific sub-branches, at 714, a generative model prompt may be generated for the second request text field using the prompt document subset for the second request text field. At 712, the generative model prompt may be analyzed, using a machine learning justification classifier model, to determine whether a mandatory justification is required. In the event that a mandatory justification is required, at 716, the generative model prompt may be modified to define the mandatory justification. At 718, the generative model prompt (and/or the modified generative model prompt) may be provided as input to a LLM to receive a generative text field corresponding to the second request text field.

With reference to a third outcome-specific sub-branch, at 720, a predefined generative text template may be identified for the third outcome and the generative text field may be generated based on the predefined generative text template without providing a prompt to an LLM.

With reference to a fourth outcome-specific sub-branch, at 722, a generative model prompt may be generated for the second request text field using the prompt document subset. At 724, the generative model prompt may be provided as input to a LLM to receive a generative text field corresponding to the second request text field.

With reference to a fifth outcome-specific sub-branch, at 726, a generative model prompt may be generated for the second request text field using the prompt document subset. At 728, the generative model prompt may be extended to account for one or more mandatory justifications corresponding to the fifth outcome. At 730, the extended generative model prompt may be provided as input to an LLM to receive a generative text field corresponding to the second request text field. At 732, the generative text field may be evaluated (e.g., using one or more evaluation techniques described herein) to determine an evaluation score for the generative text field. At 734, the evaluation score may be compared to an evaluation threshold. In the event that the evaluation score achieves an evaluation threshold, the fifth outcome-specific sub-branch proceeds to 736. Otherwise, the fifth outcome-specific sub-branch returns to 730 to generate another generative text field. At 736, the generative text field may be provided to the LLM with a prompt to modify the generative text field based on one or more post-processing criteria (e.g., to make the generative text field more polite, etc.).

At 738, the outputs (e.g., generative text fields, etc.) from each of the branches of the branched processing architecture may be combined to generate a set of generative text fields in response to a generative text request. In this manner, the techniques of the present disclosure may be tailored to specific text generation domains. By doing so, the feature engineering and/or quality assessment techniques of the present disclosure may be modified, arranged, and/or specially configured to intelligently process a generative text request based on criteria specific to a text generation domain. This, in turn, may save computing resources, such as processing and memory resources, by removing redundant computing processes, while satisfying complex criteria sets within a text generation domain.

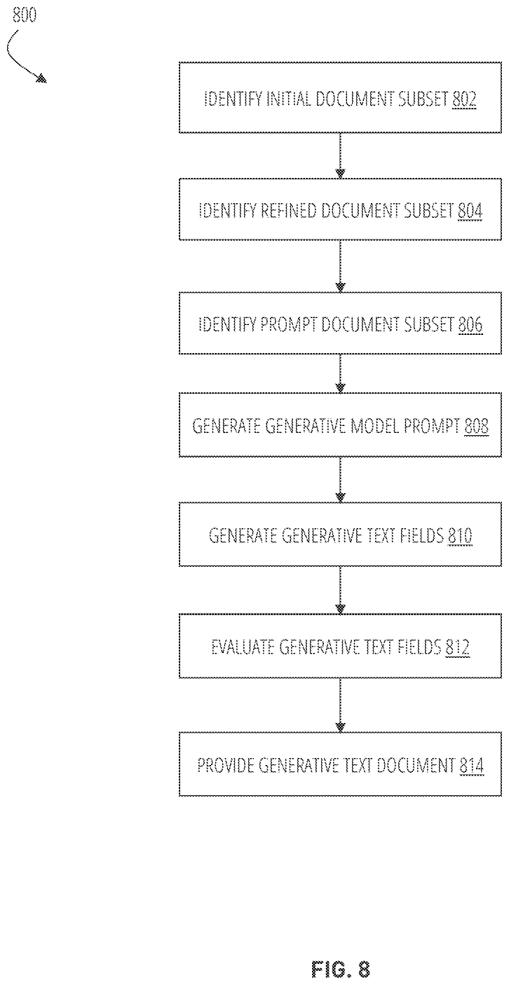

FIG. 8 is a flowchart diagram of an example process 800 for generating a generative text document in accordance with some embodiments discussed herein. The flowchart depicts a generative text process 800 for improving the language modelling operations with respect to diverse use cases. The process 800 may be implemented by one or more computing devices, entities, and/or systems described herein. For example, via the various steps/operations of the process 800, the computing system 101 may leverage improved prompt engineering and quality assessment techniques to generate and evaluate generative text produced by an LLM. By doing so, the process 800 enables the generation of text that automatically adapts to a particular use case, while ensuring data quality in view of various controlling rules.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 includes, at step/operation 802, identifying an initial document subset. For example, the computing system 101 may identify, from a document data store, the initial document subset for a generative text request that includes a request to generate a generative text document based on one or more request text fields. In some examples, the generative text request includes a category field that identifies a predefined category type corresponding to the one or more request text fields and the initial document subset includes a plurality of historical text documents that correspond to the predefined category type.

In some embodiments, the computing system 101 receives, via an API call, the generative text request. The API call, for example, may be initiated from a generative service plug-in associated with a user device (e.g., a client computing entity 102, etc.). The computing system 101 may provide, in response to the API call, a request identifier for the generative text request and temporarily store the generative text request with the request identifier in a processing queue. The initial document subset may be identified before and/or after the generative text request is pulled from the queue.

In some embodiments, the process 800 includes, at step/operation 804, identifying a refined document subset. For example, the computing system 101 may generate, using a machine learning classifier model, a contextual classification for the one or more request text fields of a generative text request. The computing system 101 may identify, from the initial document subset, a refined document subset based on the contextual classification. In some examples, the document data store includes a plurality of historical text documents and a plurality of contextual classification labels respectively corresponding to the plurality of historical text documents. The machine learning classifier model may be previously trained using the plurality of contextual classification labels as a plurality of ground truths.

In some embodiments, the process 800 includes, at step/operation 806, identifying a prompt document subset. For example, the computing system 101 may generate, using a machine learning embedding model, one or more request field embeddings respectively corresponding to the one or more request text fields. The computing system 101 may identify, from the refined document subset, a prompt document subset based on the one or more request field embeddings. In some examples, the document data store includes a plurality of historical text documents and a plurality of historical field embeddings respectively corresponding to the plurality of historical text documents. The prompt document subset may be based on a plurality of embedding similarity scores between the one or more request field embeddings and the plurality of historical field embeddings.

In some embodiments, the prompt document subset is based on a related document threshold indicative of a threshold number of prompt examples for the generative model prompt. For example, a first portion of the prompt document subset may include one or more first historical text documents that are associated with one or more highest embedding similarity scores from the plurality of embedding similarity scores and a second portion of the prompt document subset may include one or more second historical text documents that are randomly sampled from the refined document subset.

In some embodiments, the process 800 includes, at step/operation 808, generating a generative model prompt. For example, the computing system 101 may generate the generative model prompt based on the prompt document subset and the one or more request text fields.

In some embodiments, the process 800 includes, at step/operation 810, generating one or more generative text fields. For example, the computing system 101 may generate, using an LLM, one or more generative text fields using the generative model prompt.

In some embodiments, the process 800 includes, at step/operation 812, evaluating the one or more generative text fields. For example, the computing system 101 may generate a plurality of evaluation metrics based on a comparison between the one or more request text fields and the one or more generative text fields. The plurality of evaluation metrics, for example, may include a BLEU metric, a ROUGE metric, a METEOR metric, and/or the like. The computing system 101 may generate, using a rating simulation model, an inferred human rating score for the one or more generative text fields based on the plurality of evaluation metrics. In some examples, the LLM may be trained to maximize the inferred human rating score.

In some embodiments, the rating simulation model is previously trained using a plurality of historical request-generative text field pairs. For example, each historical request-generative text field pair of the plurality of historical request-generative text field pairs may be associated with a plurality of historical evaluation metrics and a manual label.

In some embodiments, the process 800 includes, at step/operation 814, providing a generative text document. For example, the computing system 101 may provide a request response including the generative text document based on the one or more generative text fields. In some examples, the computing system 101 may store the generative text document with the request identifier in a completed queue. The computing system 101 may receive a status request including the request identifier and, in response to the status request, provide the generative text document to the user device.

Some techniques of the present disclosure enable the generation of action outputs that may be performed to initiate one or more real world actions to achieve real-world effects. The prompt engineering and quality assessment techniques of the present disclosure may be used, applied, and/or otherwise leveraged to generate reliable text, which may help in the creation and provisioning of messages across computing entities, as well as other downstream tasks. For instance, the generative text output, using some of the techniques of the present disclosure, may trigger the performance of actions at a client device, such as the display, transmission, and/or the like of data reflective of generative text. In some embodiments, the generative text may trigger an alert of an appeal decision in a healthcare scenario. The alter may be automatically communicated to a user associated with the appeal decision. In addition, or alternatively, the generative text may trigger an allocation of currency, mailing of a physical letter, and/or the like. Moreover, quality assessment techniques, and/or the evaluation measures output using the quality assessment techniques, thereof, may trigger similar tasks. In some examples, the evaluation measures, such as an inferred human rating score, may trigger one or more automated training operations, such as those described herein, for one or more machine learning models of the present disclosure.

In some examples, the computing tasks may include actions that may be based on a text generation domain. A text generation domain may include any environment in which computing systems may be applied to generate text and initiate the performance of computing tasks responsive to the generative text. These actions may cause real-world changes, for example, by controlling a hardware component, providing alerts, interactive actions, and/or the like. For instance, actions may include the initiation of automated instructions across and between devices, automated notifications, automated scheduling operations, automated precautionary actions, automated security actions, automated data processing actions, and/or the like.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

### Example 1

A computer-implemented method comprising identifying, by one or more processors and from a document data store, an initial document subset for a generative text request that comprises a request to generate a generative text document based on one or more request text fields; generating, by the one or more processors and using a machine learning classifier model, a contextual classification for the one or more request text fields; identifying, by the one or more processors and from the initial document subset, a refined document subset based on the contextual classification; generating, by one or more processors and using a machine learning embedding model, one or more request field embeddings respectively corresponding to the one or more request text fields; identifying, by the one or more processors and from the refined document subset, a prompt document subset based on the one or more request field embeddings; generating, by the one or more processors and using a large language model (LLM), one or more generative text fields using a generative model prompt based on the prompt document subset and the one or more request text fields; and providing, by the one or more processors, a request response comprising the generative text document based on the one or more generative text fields.

### Example 2

The computer-implemented method of example 1, wherein the generative text request comprises a category field that identifies a predefined category type corresponding to the one or more request text fields and the initial document subset comprises a plurality of historical text documents that correspond to the predefined category type.

### Example 3

The computer-implemented method of any of the above examples, wherein the document data store comprises a plurality of historical text documents and a plurality of contextual classification labels respectively corresponding to the plurality of historical text documents, and (ii) the machine learning classifier model is previously trained using the plurality of contextual classification labels as a plurality of ground truths.

### Example 4

The computer-implemented method of any of the above examples, wherein (i) the document data store comprises a plurality of historical text documents and a plurality of historical field embeddings respectively corresponding to the plurality of historical text documents, and (ii) the prompt document subset is based on a plurality of embedding similarity scores between the one or more request field embeddings and the plurality of historical field embeddings.

### Example 5

The computer-implemented method of example 4, wherein (i) the prompt document subset is based on a related document threshold indicative of a threshold number of prompt examples for the generative model prompt, (ii) a first portion of the prompt document subset comprises one or more first historical text documents that are associated with one or more highest embedding similarity scores from the plurality of embedding similarity scores, and (iii) a second portion of the prompt document subset comprises one or more second historical text documents that are randomly sampled from the refined document subset.

### Example 6

The computer-implemented method of any of the above examples, further comprising generating a plurality of evaluation metrics for the LLM based on a comparison between the one or more request text fields and the one or more generative text fields; generating, using a rating simulation model, an inferred human rating score for the one or more generative text fields based on the plurality of evaluation metrics; and training the LLM to maximize the inferred human rating score.

### Example 7

The computer-implemented method of example 6, wherein the plurality of evaluation metrics comprises a Bilingual Evaluation Understudy (BLEU) metric, a Recall-Oriented Understudy for Gisting Evaluation (ROUGE) metric, and a Metric for Evaluation of Translation with Explicit Ordering (METEOR) metric.

### Example 8

The computer-implemented method of examples 6 or 7, wherein (i) the rating simulation model is previously trained using a plurality of historical request-generative text field pairs, and (ii) each historical request-generative text field pair of the plurality of historical request-generative text field pairs is associated with a plurality of historical evaluation metrics and a manual label.

### Example 9

The computer-implemented method of any of the above examples, further comprising receiving, via an application programming interface (API) call, the generative text request, wherein the API call is initiated from a generative service plug-in associated with a user device; providing, in response to the API call, a request identifier for the generative text request; and storing the generative text request with the request identifier in a processing queue.

### Example 10

The computer-implemented method of example 9, further comprising storing the generative text document with the request identifier in a completed queue; receiving a status request comprising the request identifier; and in response to the status request, providing the generative text document to the user device.

### Example 11

A computing system comprising memory and one or more processors communicatively coupled to the memory, the one or more processors configured to identify, from a document data store, an initial document subset for a generative text request that comprises a request to generate a generative text document based on one or more request text fields; generate, using a machine learning classifier model, a contextual classification for the one or more request text fields; identify, from the initial document subset, a refined document subset based on the contextual classification; generate, using a machine learning embedding model, one or more request field embeddings respectively corresponding to the one or more request text fields; identify, from the refined document subset, a prompt document subset based on the one or more request field embeddings; generate, using a large language model (LLM), one or more generative text fields using a generative model prompt based on the prompt document subset and the one or more request text fields; and provide a request response comprising the generative text document based on the one or more generative text fields.

### Example 12

The computing system of example 11, wherein the generative text request comprises a category field that identifies a predefined category type corresponding to the one or more request text fields and the initial document subset comprises a plurality of historical text documents that correspond to the predefined category type.

### Example 13

The computing system of examples 11 or 12, wherein (i) the document data store comprises a plurality of historical text documents and a plurality of contextual classification labels respectively corresponding to the plurality of historical text documents, and (ii) the machine learning classifier model is previously trained using the plurality of contextual classification labels as a plurality of ground truths.

### Example 14

The computing system of any of examples 11 through 13, wherein (i) the document data store comprises a plurality of historical text documents and a plurality of historical field embeddings respectively corresponding to the plurality of historical text documents, and (ii) the prompt document subset is based on a plurality of embedding similarity scores between the one or more request field embeddings and the plurality of historical field embeddings.

### Example 15

The computing system of example 14, wherein (i) the prompt document subset is based on a related document threshold indicative of a threshold number of prompt examples for the generative model prompt, (ii) a first portion of the prompt document subset comprises one or more first historical text documents that are associated with one or more highest embedding similarity scores from the plurality of embedding similarity scores, and (iii) a second portion of the prompt document subset comprises one or more second historical text documents that are randomly sampled from the refined document subset.

### Example 16

The computing system of any of examples 11 through 15, wherein the one or more processors are further configured to generate a plurality of evaluation metrics for the LLM based on a comparison between the one or more request text fields and the one or more generative text fields; generate, using a rating simulation model, an inferred human rating score for the one or more generative text fields based on the plurality of evaluation metrics; and train the LLM to maximize the inferred human rating score.

### Example 17

The computing system of example 16, wherein the plurality of evaluation metrics comprises a Bilingual Evaluation Understudy (BLEU) metric, a Recall-Oriented Understudy for Gisting Evaluation (ROUGE) metric, and a Metric for Evaluation of Translation with Explicit Ordering (METEOR) metric.

### Example 18

One or more non-transitory computer-readable storage media including instructions that, when executed by one or more processors, cause the one or more processors to identify, from a document data store, an initial document subset for a generative text request that comprises a request to generate a generative text document based on one or more request text fields; generate, using a machine learning classifier model, a contextual classification for the one or more request text fields; identify, from the initial document subset, a refined document subset based on the contextual classification; generate, using a machine learning embedding model, one or more request field embeddings respectively corresponding to the one or more request text fields; identify, from the refined document subset, a prompt document subset based on the one or more request field embeddings; generate, using a large language model (LLM), one or more generative text fields using a generative model prompt based on the prompt document subset and the one or more request text fields; and provide a request response comprising the generative text document based on the one or more generative text fields.

### Example 19

The one or more non-transitory computer-readable storage media of example 18, wherein the instructions further cause the one or more processors to receive, via an application programming interface (API) call, the generative text request, wherein the API call is initiated from a generative service plug-in associated with a user device; provide, in response to the API call, a request identifier for the generative text request; and store the generative text request with the request identifier in a processing queue.

### Example 20

The one or more non-transitory computer-readable storage media of example 19, wherein the instructions further cause the one or more processors to store the generative text document with the request identifier in a completed queue; receive a status request comprising the request identifier; and in response to the status request, provide the generative text document to the user device.

### Example 21

The computer-implemented method of example 1, wherein the method further comprises training the machine learning classifier model, the machine learning embedding model, and the LLM.

### Example 22

The computer-implemented method of example 21, wherein the training is performed by the one or more processors.

### Example 23

The computer-implemented method of example 21, wherein the one or more processors are included in a first computing entity; and the training is performed by one or more other processors included in a second computing entity.

### Example 24

The computing system of example 11, wherein the one or more processors are further configured to train the machine learning classifier model, the machine learning embedding model, and the LLM.

### Example 25

The computing system of example 11, wherein the one or more processors are included in a first computing entity; and the machine learning classifier model, the machine learning embedding model, and the LLM are trained by one or more other processors included in a second computing entity.

### Example 26

The one or more non-transitory computer-readable storage media of example 18, wherein the instructions further cause the one or more processors to train the machine learning classifier model, the machine learning embedding model, and the LLM.

### Example 27

The one or more non-transitory computer-readable storage media of example 18, wherein the one or more processors are included in a first computing entity; and the machine learning classifier model, the machine learning embedding model, and the LLM are trained by one or more other processors included in a second computing entity.

1. A computer-implemented method comprising:
identifying, by one or more processors and from a document data store, an initial document subset for a generative text request;
generating, by the one or more processors and using a machine learning classifier model, a contextual classification for the one or more request text fields; and
providing, by the one or more processors, the contextual classification.
